(19) United States
(12) Patent Application Publication
(10) Pub. No.: US 2014/0191509 A1
(43) Pub. Date: Jul. 10, 2014

(54) Stauffer submerged electricity generator

(71) Applicant: David William Stauffer, Portland, OR (US)

(72) Inventor: David William Stauffer, Portland, OR (US)

(21) Appl. No.: 13/734,979

(22) Filed: Jan. 6, 2013

(51) Int. Cl. F03B 13/10

(52) U.S. Cl. CPC F03B 13/10; F03B 17/04
USPC 290/54; 74/DIG. 9

(57) ABSTRACT

A submerged waterfall hydroelectric energy generator using a submerged ocean or lake siphon pipeline and gravity for the production of hydroelectric power.

### RELATED APPLICATIONS

There are no related applications.

### FEDERALLY-SPONSORED RESEARCH

This invention was not invented through federally sponsored research or development.

### JOINT RESEARCH AGREEMENT

There is no joint research agreement.

### SEQUENCE LISTING

There is no reference to a “Sequence Listing”.

### BACKGROUND OF THE INVENTION

It is common knowledge that large electricity generators produce a large current of electricity from dammed reservoirs. The standard method of operation is that a large reservoir of water is created by damming a river and then allowing a tunnel or pipeline, at the bottom of the dam, of water to flow past the turbines on the generators to turn the turbines of the hydroelectric power generator and create electricity. Inventor Stauffer has invented an alternative method by which to create the pipeline of water to turn the turbines of the hydroelectric power generator, which does not require a dam nor a reservoir of water behind the dam. Instead, the powerful flow of water can be created by submerged pipelines that flow from higher elevations to lower elevations.

Inventor Stauffer also perceives the need to solve the following problems:
1. The world needs to lower carbon emissions (e.g., the smoke that is emitted from the burning of coal) from present methods of creating electricity,
2. The world needs to stop the depletion of the ozone layer around the poles,
3. The world needs to decrease global warming,
4. The world needs to find an alternative source of hydroelectric energy so that dams may be breached and traditional fish migrations for the purpose of spawning up-stream may be restored.

### The Science of Siphons

The science of siphons and how they work is well settled. Wikipedia has the following explanation under the word “siphon”:

The word siphons is sometimes used to refer to a wide variety of devices that involve the flow of liquids through tubes but in the narrower sense it refers specifically to a tube in an inverted U shape which causes a liquid to flow uphill, above the surface of the reservoir, without pumps, powered by the fall of the liquid as it flows down the tube under the pull of gravity, and is discharged at a level lower than the surface of the reservoir. Note that while the siphon must touch the liquid in the (upper) reservoir (the surface of the liquid must be above the intake opening), it need not touch the liquid in the lower reservoir and indeed there need not be a lower reservoir—liquid can discharge into mid-air.

In practical siphons, atmospheric pressure pushes the liquid up the tube into the region of reduced pressure at the top of the tube in the same way as a barometer, and indeed the maximum height of a siphon is the same as the height of a barometer, because they operate by the same mechanism. The reduced pressure is caused by liquid falling on the exit side.

When both ends of a siphon are at atmospheric pressure, liquid flows from high to low. However, if the lower end is pressurized, liquid can flow from low to high, as in siphon coffee. While in everyday siphons, atmospheric pressure is the driving mechanism, in specialized circumstances other mechanisms can work—in the laboratory, some siphons have been demonstrated to work in a vacuum, indicating the tensile strength of the liquid is contributing to the operation of siphons at very low pressures. Most familiar siphons have water as a fluid, though mercury is often used in experiments, and other fluids such as organic liquids or even carbon dioxide can be siphoned.

### History

Egyptian reliefs from 1500 BC depict siphons used to extract liquids from large storage jars. There is physical evidence for the use of siphons by Greek engineers in the 3rd century BC at Pergamon. Hero of Alexandria wrote extensively about siphons in the treatise Pneumatica. In the 9th century, the Banu Musa brothers invented a double-concentric siphon, which they described in their Book of Ingenious Devices. The edition edited by Hill includes an Analysis of the double-concentric siphon.

Siphons were studied further in the 17th century, in the context of suction pumps (and the recently developed vacuum pumps), particularly with an eye to understanding the maximum height of pumps (and siphons) and the apparent vacuum at the top of early barometers. This was initially explained by Galileo via the theory of horror vacui (“nature abhors a vacuum”), which dates to Aristotle, and which Galileo restated as resintenza del vacuo, but this was subsequently disproved by later workers, notably Evangellista Torricelli and Blaise Pascal.

Specifically, Pascal demonstrated that siphons work via atmospheric pressure (as Torricelli had advocated), not viahorror vacui, via the following experiment. Two beakers of mercury are placed in a large container, at different heights. The beakers are connected with a three-way tube: a regular siphon (U-shaped tube), with an additional tube extending upward from the hook in the tube: one end of the tube goes down into each beaker (as in a normal siphon), while the third end laces upward, and is open to the air. The large container is slowly filled with water (the tube remains open to the air): us water goes into the container, the weight of the water threes the mercury up into the tube (water being denser hence heavier than air)—as the water level increases, the level of mercury rises because the pressure increases—and once the mercury enters the top of the siphon, the mercury flows from the higher beaker to the lower, as in a standard siphon. As the mercury had been open to the air at all time, there was never a vacuum—it was instead the pressure of the water.

### Operation

There are two main issues in the operation of a siphon:
why liquid flows from the higher reservoir to the lower reservoir, which is basic; and
why liquid flows up the siphon, which is subtler.

The first issue is basic: liquid flows from the higher level to the lower level because the lower location has lower potential energy—water flows downhill. This is independent of the particular connection—liquids will also flow from higher to lower if there is a direct path (a canal), or if there is a tube that goes below the reservoirs (an “inverse” siphon), and these do not depend on siphon effect. Note that this is due to different heights (moving in the direction of gravity), not due to differences in atmospheric pressure at different heights (in fact, lower locations will, all else equal, have higher atmospheric pressure, due to a longer column of air above).

The second issue, why liquid flows up, is due primarily to atmospheric pressure (in ordinary siphons), and is the same mechanism as in suction pumps, vacuum, pumps, and barometers, and can be replicated in the simple experiment of placing a straw in water, capping the top, and pulling it up (leaving the bottom tip submerged).

### Theory

A siphon works because gravity pulling down on the taller column of liquid causes reduced pressure at the top of the siphon (formally, hydrostatic pressure). This reduced pressure means gravity pulling down on the shorter column of liquid is not sufficient to keep the liquid stationary so it flows from the upper reservoir, up and over the top of the siphon.

Looking at FIG. 2, one can look at how the hydrostatic pressure varies through the siphon, considering in turn the vertical tube from the top reservoir, the vertical tube from the bottom reservoir, and the horizontal tube connecting them (assuming a U-shape). At liquid level in the top reservoir, the liquid is under atmospheric pressure, and as one goes up the siphon, the hydrostatic pressure decreases since the weight of atmospheric pressure pushing the water up is counterbalanced by the column of water in the siphon pushing down (until one reaches the maximum height of a barometer/siphon, at which point the liquid cannot be pushed higher)—the hydrostatic pressure at the top of the tube is then lower than atmospheric pressure by an amount proportional to the height of the tube. Doing the same analysis on the tube rising from the lower reservoir yields the pressure at the top of that (vertical) tube; this pressure is lower because the tube is longer (there is more water pushing down), and requires that the lower reservoir is lower than the upper reservoir, or more generally that the discharge outlet simply be lower than the surface of the upper reservoir. Considering now the horizontal tube connecting them, one sees that the pressure at the top of the tube from the top reservoir is higher (since less water is being lifted), while the pressure at the to of the tube from the bottom reservoir is lower (since more water is being lifted), and since liquids move from high pressure to low pressure, the liquid flows across the horizontal tube from the top basin to the bottom basin. Note that the liquid is under positive pressure (compression) throughout the tube, not tension.

When the column of liquid is allowed to fall, in FIG. 2, from C down to D, liquid in the upper reservoir will flow up to B and over the top. No liquid tensile strength is needed.

An occasional misunderstanding of siphons is that they rely on the tensile strength of the liquid to pull the liquid up and over the rise. While water has been found to have a great deal of tensile strength in some experiments (such as with the z-tube), and siphons in vacuum rely on such cohesion, common siphons can easily be demonstrated to need no liquid tensile strength at all to function. Furthermore, since common siphons operate at positive pressures throughout the siphon, there is no contribution from liquid tensile strength, because the molecules are actually repelling each other in order to resist the pressure, rather than pulling on each other. To demonstrate, the longer lower leg of a common siphon can be plugged at the bottom and filled almost to the crest with liquid, leaving the top and the shorter upper leg completely dry and containing only air. When the plug is removed and the liquid in the longer lower leg is allowed to fall, the liquid in the upper reservoir will then typically sweep the air bubble down and out of the tube. The apparatus will then continue to operate as a siphon. As there is no contact between the liquid on either side of the siphon at the beginning of this experiment, there can be no cohesion between the liquid molecules to pull the liquid over the rise. Another simple demonstration that liquid tensile strength isn't needed in the siphon is to simply introduce a bubble into the siphon during operation. The bubble can be large enough to entirely disconnect the liquids in the tube before and after it, defeating any liquid tensile strength, and yet if the bubble isn't too big, the siphon will continue to operate with little change.

The uphill flow of water in a siphon doesn't violate the principle of continuity because the mass of water entering the tube and flowing upwards is equal to the mass of water flowing downwards and leaving the tube. A siphon doesn't violate the principle of conservation of energy because the loss of gravitational potential energy as liquid flows from the upper reservoir to the lower reservoir equals the work done in overcoming fluid friction as the liquid flows through the tube. Once started, a siphon requires no additional energy to keep the liquid flowing up and out of the reservoir. The siphon will draw liquid out of the reservoir until the level falls below the intake, allowing air or other surrounding gas to break the siphon, or until the outlet of the siphon equals the level of the reservoir, whichever comes first.

In addition to atmospheric pressure, the density of the liquid, and gravity, the maximum height of the crest is limited by the vapor pressure of the liquid. When the pressure within the liquid drops to below the liquids vapor pressure, tiny vapor bubbles can begin to form at the high point and the siphon effect will end. This effect depends on how efficiently the liquid can nucleate bubbles; in the absence of impurities or rough surfaces to act as easy nucleation site for bubbles, siphons can temporarily exceed their standard maximum height during the extended time it takes bubbles to nucleate. For water at standard atmospheric pressure, the maximum siphon height is approximately 10 m (32 feet); for mercury it is 76 cm (30 inches), which is the definition of standard pressure. This equals the maximum height of a suction pump, which operates by the same principle. The ratio of heights (about 13.6) equals the ratio of densities of water and mercury (at a given temperature), since the column of water (resp. mercury) is balancing with the column of air yielding atmospheric pressure, and indeed maximum height is (neglecting vapor pressure and velocity of liquid) inversely proportional to density of liquid.

### Chain Analogy

The chain model is a flawed analogy to the operation of a siphon in ordinary conditions.

A simplified but misleading conceptual model of a siphon is that it is like a chain hanging over a pulley with one end of the chain piled on a higher surface than the other (see FIG. 3). Since the length of chain on the shorter side is lighter than the length of chain on the taller side, the chain will move up around the pulley and down towards the lower surface.

There are a number of problems with the chain model of a siphon, and understanding these differences helps to explain the actual workings of siphons. The first is in practical siphons, the liquid is pushed through the siphon, not pulled. That is, under most practical circumstances, dissolved gases, vapor pressure, and (sometimes) lack of adhesion with tube walls, conspire to render the tensile strength within the liquid ineffective for siphoning. Thus, unlike a chain which has significant tensile strength, liquids usually have little tensile strength under typical siphon conditions, and therefore the liquid on the rising side cannot be pulled up, in the way the chain is pulled up on the rising side.

A related problem is that siphons have a maximum height (for water siphons at standard atmospheric pressure, about 10 meters), as this is the limit to how high atmospheric pressure will push the water, but the chain model has no such limit—or rather is instead limited by how strong the links are (above a certain height, the chain links could not support the weight of the hanging chain and the links would snap), corresponding to tensile strength of the liquid, which is not the cause of maximum height in siphons.

In FIG. 4, even the falling lighter lower leg from C to D can cause the liquid of the heavier upper leg to flow up and over into the lower reservoir

A further problem with the chain model of the siphon is that siphons work by a gradient of hydrostatic pressure within the siphon, not by absolute differences of weight on either side. The weight of liquid on the up side of the siphon can be greater than the liquid on the down side, yet the siphon can still function. For example, if the tube from the upper reservoir to the top Of the siphon has a much larger diameter than the section of tube from the lower reservoir to the top of the siphon, the shorter upper section of the siphon may have a much larger weight of liquid in it, yet the siphon can function normally—this is because hydrostatic pressure depends an height (reduces as one goes up a column), but does not depend on diameter of the tube.

Despite these shortcomings, in some situations siphons do function in the absence of atmospheric pressure and via tensile strength and in these situations the chain model can be instructive. Further, in other settings water transport does occur via tension, most significantly in transpirational pull in the xylem of vascular plants.

### Practical Requirements

A plain tube can be used as a siphon. An external pump has to be applied to start the liquid flowing and prime the siphon. This can be a human mouth. This is sometimes done with any leak-free hose to siphon gasoline from a motor vehicle's gasoline tank to an external tank. (Siphoning gasoline by mouth often results in the accidental swallowing of gasoline, which is quite poisonous, or aspirating it into the lungs, which can cause death or lung damage). If the tube is flooded with liquid before part of the tube is raised over the intermediate high point and care is taken to keep the tube flooded while it is being raised, no pump is required. Devices sold as siphons conic with a siphon pump to start the siphon process. When applying a siphon to any application it is important that the piping be as closely sized to the requirement as possible. Using piping of too great a diameter and then throttling the flow using valves or constrictive piping appears to increase the effect of previously cited concerns over gases or vapor collecting in the crest which serve to break the vacuum. Once the vacuum is reduced the siphon effect is lost.

Reducing the size of pipe used closer to requirements appears to reduce this effect and creates a more functional siphon that does not require constant re-priming and restarting. In this respect, where the requirement is to match a flow into a container with a flow out of said container (to maintain a constant level in a pond fed by a stream, for example) it would be preferable to utilize two or three smaller separate parallel pipes that can be started as required rather than attempting to use a single large pipe and attempting to throttle it.

### The Scientific Solution of the Perceived Needs

A forceful stream of water can be fabricated with a siphon tube, or pipeline, that will flow from the top part of the Ocean or lake or reservoir (e.g., 10 meters below the surface of a lake or ocean) to a lower level in the same lake or ocean (e.g. 60 meters below the surface of a lake or ocean) and that forceful stream of water can turn the turbines of an electricity generator and generate electricity. An existing example of a flow of water from the upper part of a dammed reservoir to a lower level is the “glory hole” of the Monticello Dam in California. That hole's suction of water from the upper level is an example of a large pipeline that drops 14,400 cubic feet of water per second down the “glory hole” pipeline. Such a forceful current of water could easily turn the turbines of a hydroelectric generator.

David W. Stauffer will make the patent claims, below, on the following invention of a submerged ocean or lake or reservoir hydroelectric plant:
1. The hydroelectric plant shall have an air-tight and water-tight plastic pipeline (2 in FIG. 1) that consists, in one embodiment, of a pipeline that is about 10 meters in diameter, and that runs from the pipeline's upper level water intake (1 in FIG. 1) at the upper part of an ocean or lake or reservoir, e.g., 10 meters below the water surface (deep enough so that no ships or boats will collide with the pipeline) (Point A in FIG. 1) to a bend point that is lower in the same ocean or lake or reservoir (e.g., 60 meters below the upper water intake opening) (Point B in FIG. 1), and then through a connected horizontal pipeline to an output point (Point C in FIG. 1) which is inside an airtight hell (open to the water at the bottom of the bell with a captive air bubble inside the bell) (3 in FIG. 1) capable of permanently holding a bubble of air that the water will encounter when it leaves the water output (5) (at Point C in FIG. 1). Such pipeline can be primed by insertion of the pipeline in the ocean or lake and then powering the generator turbines in the bottom part of the pipeline so that the paddles of the turbine can push the water in the pipeline out the water output (5 at Point C in FIG. 1). At point C, the water in the pipeline will be expelled from the pipeline and then the higher ocean or lake water will drop into the void lea by the draining of the water from the pipe, resulting in a water rush into the upper opening of the pipeline (1) (at Point A in FIG. 1). That water will then drop by the force of gravity, and flow through the pipeline and out of the output opening (5) (at Point C in FIG. 1) so that more water is sucked into the upper intake to create the constant flow of water through the pipeline by the force of gravity. Once the powered generator turbine has started, or primed, the flow of water out of the lower level output, the upper water will continue to fall into the upper intake and, by the force of gravity, will waterfall to the bottom point (B) and flow past the generator (4) turbines to create electricity, and then proceed out the lower water output (5) (Point C in FIG. 1).
2. The lower water output (5) (Point C in FIG. 1) will be the end of the pipeline which is bent so that it releases the water upward towards the upper water surface of the ocean or lake or reservoir. This water output point shall be within an air bubble which is trapped and held in place by a sturdy bell-shaped metal or heavy plastic bell-shaped dome that is capable of both keeping an air bubble in its bell, at whatever water depth it is located, and supporting the weight of the water on the outside—water side—top of the bell. The bottom of the bell, like all bells, shall be open to the water below the bell. That water will not displace the air bubble because the pressure of the water below the bell will not be great enough to either compress or eliminate the air pressure of the air inside the bell's dome. The normal pressure of the water at lower depths will be decreased for the water at the bottom of the bell because the metal or heavy plastic dome will bear the weight of the water above the dome. The output water will freely flow into this air bubble without encountering the resistance that it would encounter if the water was being released into the water on the outside of the dome. The output water will be released into the bubble of air and then, by the force of gravity, fall to the bottom water level of the open bell, where it will be absorbed into that lower water level.
3. The top half of the generator (4) will be in an air-tight and water-tight compartment's air bubble (3) so that the turbine blades will not encounter the resistance that they would encounter if the entire turbine was in water. Because the air cannot escape from the air-tight dome (3), any water spun up from the turbine blades will fall down to the open bottom of the air bubble and mix with the water flowing through the pipeline.
4. On this submerged pipeline (2 in FIG. 1), install a submerged hydroelectric generation plant (4 in FIG. 1) to generate electricity by turbines run by the water that flows through the pipeline by the force of gravity.
5. Use this invention in every ocean, reservoir and big lake around the world to bring electricity to the whole world.

In 2012, the Manual of Patent Examining Procedures (MPEP) was revised as follows:

Patent Revision of 2012; MPEP 2173.05 states:

2173.05(j) Old Combination

A CLAIM SHOULD NOT BE REJECTED ON THE GROUND OF OLD COMBINATION

With the passage of the 1952 Patent Act, the courts and the Board have taken the view that a rejection based on the principle of old combination is NO LONGER VALID. Claims should be considered proper so long as they comply with the provisions of 35 U.S.C. 112, second paragraph.

A rejection on the basis of old combination was based on the principle applied in Lincoln Engineering Co. v. Stewart-Warner Corp., 303 U.S. 545, 37 USPQ 1 (1938). The principle was that an inventor who made an improvement or contribution to but one element of a generally old combination, should not be able to obtain a patent on the entire combination including the new and improved element. A rejection required the citation of a single reference which broadly disclosed a combination of the claimed elements functionally cooperating in substantially the same manner to produce substantially the same results as that of the claimed combination. The case of In re Hall, 208 F.2d 370, 100 USPQ 46 (CCPA 1953) illustrates an application of this principle.

The court pointed out in In re*>Bernhart<, 417 F.2d 1395, 163 USPQ 611 (CCPA 1969) that the statutory language (particularly point out and distinctly claim) is the only proper basis for an old combination rejection, and in applying the rejection, that language determines what an applicant has a right and obligation to do. A majority opinion of the Board of Appeals held that Congress removed the underlying rationale of Lincoln Engineering in the 1952 Patent Act, and thereby effectively legislated that decision out of existence. Ex parte Barber, 187 USPQ 244 (Bd. App. 1974). Finally, the Court of Appeals for the Federal Circuit, in Radio Steel and Mfg. Co. v. MTD Products, Inc., 731 F.2d 840, 221 USPQ 657 (Fed. Cir. 1984), followed the *>Bernhart< case, and ruled that a claim was not invalid under Lincoln Engineering because the claim complied with the requirements of 35 U.S.C. 112, second paragraph. Accordingly, a claim should not be rejected on the ground of old combination.

At first glance, it appears that most of the improvements or new contributions of inventor Stauffer are elements of an old combination of a dam and a hydroelectric plant. Indeed, the science of siphons, pipelines, air bubbles, and hydroelectric generators is well-established. Those elements are common knowledge and are the prior art of the current invention. However, it is novel to put all those elements underneath the water in an ocean, lake, or reservoir in such a manner as to generate electricity without pollution, and the energy input that is required in other existing electricity generators—such, as a coal-fired electricity generator.

MPEP 2173.05(v) states the following:

2173.05(v) Mere Function of Machine

Process or method claims are not subject to rejection by U.S. Patent and Trademark Office examiners under 35 U.S.C. 112, second paragraph, solely on the ground that they define the inherent function of a disclosed machine or apparatus. In reTarczy-Hornoch, 397 F.2d 856, 158 USPQ 141 (CCPA 1968). The court in Tarczy-Hornoch held that a process claim, otherwise patentable, should not be rejected merely because the application of which it is part discloses apparatus which will inherently carry out the recited steps.

Inventor Stauffer claims the following as being novel aspects of those old combinations:
1. Inventor Stauffer creates the gravity-driven water flow for the hydroelectric generator with a submerged pipeline rather than with a dam and reservoir of water behind the dam. Inventor Stauffer creates the flow of water by a submerged pipeline in water that is high in the water (but underneath the surface of the water) so that the water in the pipeline will flow downhill to a lower level in the ocean or lake or reservoir.
2. The electricity generator turbines will be capable of being powered so that, in addition to creating electricity by being pushed by the flow of water in the pipeline, such turbines a will also be powered by an external power source so that they are capable of pushing the water out of the pipeline.

### VIEWS OF THE DRAWINGS

FIG. 1 is a side view of the pipeline that the water enters at a high level (10 meters deep?) and then, by the force of gravity, waterfalls to a lower level (60 meters deep?) and then goes horizontally so that the flow of water can turn the blades of a hydroelectric generator, before splashing out of the other end of the pipeline into an air bubble, and dropping to be absorbed by the ocean or lake water below the air bubble.

FIGS. 2, 3, and 4 have been previously explained.

### DETAILED DESCRIPTION OF THE INVENTION

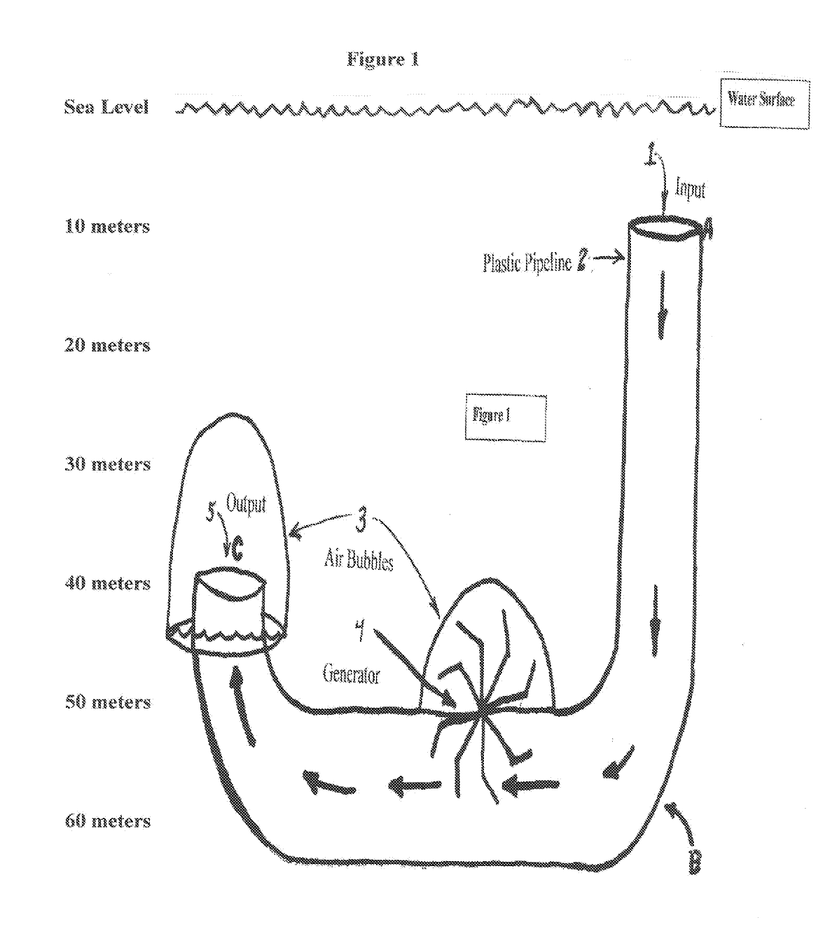

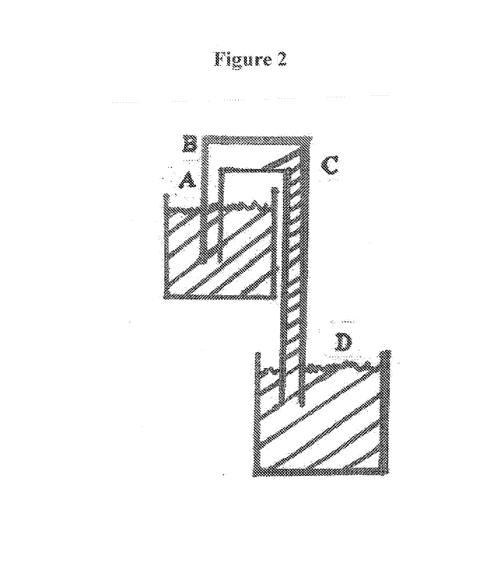

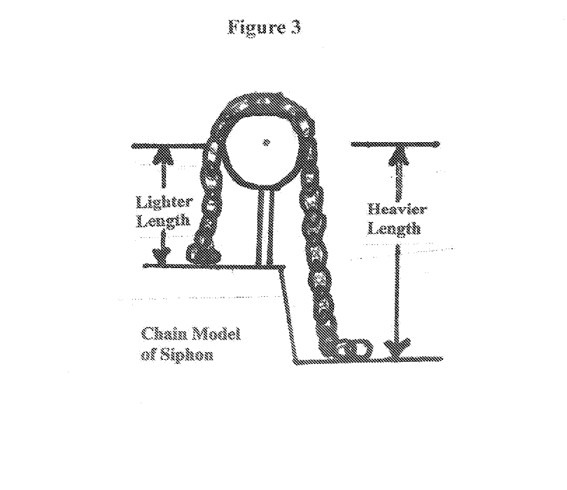

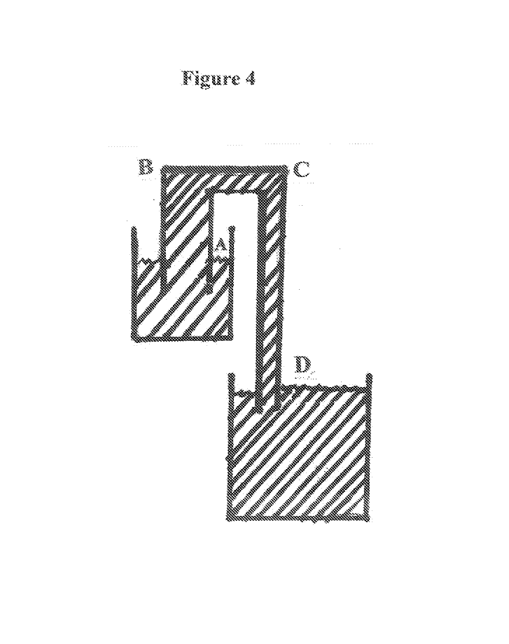

During the examination, the examiner might erroneously suggest that there is nothing that was not previously general knowledge. The examiner might argue that, even though no other scientist in human history has suggested that Stauffer's invention was possible, siphons, hydroelectric generators, and pipelines are knowledge and that it would be obvious to a person skilled in the art of siphons, hydroelectric generators, and pipelines to make inventor Stuffer's invention—that Stauffer's invention is a “mere function of machines” that are already known. Inventor Stauffer submits that:
1. It has never been obvious to anyone to submerge a siphon pipeline 10 meters under the water surface of an ocean, lake or reservoir, and
2. It has never been obvious to anyone to build structures to create air bubbles in the water (3 in FIG. 1) so that a generator (4 in FIG. 1) and the pipeline water output (5, at point C, in FIG. 1) can freely flow as propelled by the underwater waterfall of the water from point A to point B in the pipeline (2 in FIG. 1).
3. Even if the submerged pipeline and the submerged generator operated as the “mere function” of those machines, MPEP 2173.05(v) would allow inventor Stauffer to obtain a patent on the invention.

The Wikipedia explanation, above, discloses the unpatented common knowledge, state of the prior art on siphons. The siphon pipeline is unpatented common knowledge, as is the generator with turbines turned by a flow of water through a tube, as in hydroelectric dams everywhere. However, inventor Stauffer claims the following as being novel aspects of those old combinations:
3. Inventor Stauffer creates the gravity-driven water flow with a submerged pipeline rather than with a dam and reservoir of water behind the dam. Inventor Stauffer creates the flow of water through the pipeline by submerging the pipeline in water, priming it, and starting the continuous flow of water by the force of gravity, all within the body of water.
4. Although water is capable of flowing out of the output opening of the pipe directly into the lower level ocean water, it is conceivable that some embodiments of the pipeline would encounter water pressure at the lower ocean level that would equal or exceed the water pressure of the pipeline's waterfall, and thereby, stop the continuous flow of water. To eliminate this possibility, inventor Stauffer claims an open-bottom underwater air babble structure (3 in FIG. 1) that is open to the water below it so that the water flowing from the pipeline output (5, at point C, in FIG. 1) can encounter only the lesser pressure of the air bubble, and then drop to the open-water floor of the air bubble where it will be absorbed by the ocean water held down by the air bubble. Although the water could simply flow directly into the ocean water, it is a more practical model to have an air bubble which will allow the unimpeded (by the surrounding ocean bottom water pressure) flow of the pipeline's water out of the output (5, at point C, FIG. 1). The speed of the underwater flow that is created by the gravity-driven waterfall from the pipeline input (1, at point A, in FIG. 1) to point B FIG. 1 will not be impeded if there is an air bubble output port that allows the water to flow into a bubble of air created by a dome under the water, rather than directly into the higher pressure of the ocean-bottom water.
5. In similar manner, inventor Stauffer has also invented an electricity generator (4 in FIG. 1) that is partially in an air bubble so that the lower half of the turbine will be turned by the flow of the pipeline's water, while the upper half of the turbine will flow through the bubble (3 in FIG. 1) so that the upper half of the turbine turns in air and does not encounter resistance from water, as would occur if there were no air bubble.
6. The electricity generator turbines sill be powered so that, in addition to creating electricity by being pushed by the flow of water in the pipeline, such turbines, with an external power source, will be capable of pushing water out of the pipeline to prime, or re-prime, the flow of water through the pipeline.

1. An air-tight and water-tight plastic pipeline (2 in FIG. 1) that consists, in one embodiment, of a pipeline that is about 10 meters in diameter, and that runs from the pipeline's upper level water intake (1 in FIG. 1) at the upper part of an ocean or lake or reservoir, e.g., 10 meters below the water surface (deep enough so that no ships or boats will collide with the pipeline) (Point A in FIG. 1) to a bend point that is lower in the same ocean or lake or reservoir (e.g., 60 meters below the upper water intake opening) (Point B in FIG. 1), and then through a connected horizontal pipeline to an output point (Point C in FIG. 1) which is inside an airtight metal or plastic bubble capable of permanently holding a bubble of air that the water will encounter when it leaves the water output (5) (at Point C in FIG. 1). Such pipeline can be primed by insertion of the pipeline in the ocean or lake and then powering the generator turbines in the bottom part of the pipeline so that the paddles of the turbine can push the water in the pipeline out the water output (5) (at Point C in FIG. 1). At point C, the water in the pipeline will be expelled from the pipeline and then the higher ocean or lake water will rush into the upper opening of the pipeline (1) (at Point A in FIG. 1) and drop by the force of gravity, and flow through the pipeline and out of the output opening (5) (at Point C in FIG. 1) so that more water is sucked into the upper intake to create the constant flow of water through the pipeline by the force of gravity. Once the powered generator turbine has started, or primed, the flow of water out of the lower level output, the upper water will continue to fall into the upper intake and, by the force of gravity, will waterfall to the bottom point (B) and flow past the generator (4) turbines to create electricity, and then proceed out the lower water output (5) (Point C in FIG. 1).

2. The lower water output (5) (Point C in FIG. 1) will be the end of the pipeline which is bent so that it releases the water upward towards the upper water surface of the ocean or lake or reservoir. This water output point shall be within an air bubble which is trapped and held in place by a sturdy bell-shaped metal or heavy plastic dome that is capable of both keeping an air bubble in its bell, at whatever water depth it is located, and supporting the weight of the water on the outside—water side—top of the bell. The bottom of the bell, like all bells, shall be open to the water below the bell. That water will not displace the air bubble because the pressure of the water below the bell will not be great enough to either compress or eliminate the air pressure of the air inside the bell's dome. The normal pressure of the water at lower depths will be decreased for the water at the bottom of the bell because the metal or heavy plastic dome will bear the weight of the water above the dome. The output water will freely flow into this air bubble without encountering the resistance that it would encounter if the water was being released into the water on the outside of the dome. The output water will be released into the bubble of air and then, by the force of gravity, fall to the bottom water level of the open bell, where it will be absorbed into that lower water level.

3. The top half of the generator (4) will be in an air-tight and water-tight compartments air bubble (3) so that the turbine blades will not encounter the resistance that they would encounter if the entire turbine was in water. Because the air cannot escape from the air-tight dome (3), the water in the pipeline will stay in the pipeline and will not compress or eliminate the air bubble in the top half of the generator.

4. The electricity generator turbines will be powered so that, in addition to creating electricity by being pushed by the flow of water in the pipeline, such turbines, with an external power source, will be capable of pushing water out of the pipeline to prime the flow of water through the pipeline. Once primed, the external power source is stopped and the gravity-driven flow of water pushing the turbine can continue indefinitely.
